(19) United States
(12) Patent Application Publication
(10) Pub. No.: US 2025/0015451 A1
(43) Pub. Date: Jan. 9, 2025

(54) ELECTRODE PLATE ASSEMBLY, BATTERY CELL, AND ELECTRICAL DEVICE

(71) Applicant: Ningde Amperex Technology Limited, Ningde City (CN)

(72) Inventors: Xiaolong Li, Ningde City (CN); Chu Huang, Ningde City (CN); Sen Lin, Ningde City (CN)

(73) Assignee: Ningde Amperex Technology Limited, Ningde City (CN)

(21) Appl. No.: 18/761,970

(22) Filed: Jul. 2, 2024

(30) Foreign Application Priority Data
Jul. 3, 2023 (CN) 202310799954.2

(51) Int. Cl. H01M 50/533; H01M 50/536

(52) U.S. Cl. CPC H01M 50/533; H01M 50/536

(57) ABSTRACT

An electrode plate assembly includes an electrode plate and a tab. An electrode plate includes a first surface and a second surface that are disposed opposite to each other along a thickness direction of the electrode plate. The tab is disposed on the first surface and electrically connected to the electrode plate. A first bulge is disposed on the tab. A first recess is disposed on the first surface and recessed toward the second surface. The first recess does not penetrate the second surface. The first bulge is at least partially embedded into the first recess. The first bulge is at least partially embedded into the first recess to form a structure in which the electrode plate engages with the tab, thereby increasing connection strength between the tab and the electrode plate, and increasing tensile strength of the electrode plate assembly.

### CROSS REFERENCE

This application claims priority to the Chinese Patent Application Ser. No. 202310799954.2, filed on Jul. 3, 2023, the content of which is incorporated herein by reference in its entirety.

### TECHNICAL FIELD

This application relates to the field of battery technology, and in particular, to an electrode plate assembly, a battery cell, and an electrical device.

### BACKGROUND

Battery cells are widely used in the fields such as portable electronic devices, electric transportation, electric tools, unmanned aerial vehicles, and energy storage devices. With the increase of complexity of the application environment and conditions of the battery cells, higher requirements are imposed on the reliability of the battery cells in use.

### SUMMARY

In view of the above situation, this application provides an electrode plate assembly, a battery cell, and an electrical device to improve reliability of the battery cell in use.

According to a first aspect, this application provides an electrode plate assembly. The electrode plate assembly includes an electrode plate and a tab. The electrode plate includes a first surface and a second surface that are disposed opposite to each other along a thickness direction of the electrode plate. The tab is disposed on the first surface and electrically connected to the electrode plate. A first bulge is disposed on the tab. A first recess is disposed on the first surface and recessed toward the second surface. The first recess does not penetrate the second surface. The first bulge is at least partially embedded into the first recess.

In a technical solution put forward in an embodiment of this application, the electrode plate assembly includes an electrode plate and a tab. The electrode plate includes a first surface and a second surface that are disposed opposite to each other along a thickness direction of the electrode plate. The tab is disposed on the first surface and electrically connected to the electrode plate. A first bulge is disposed on the tab. A first recess is disposed on the first surface and recessed toward the second surface. The first recess does not penetrate the second surface. The first bulge is at least partially embedded into the first recess. The first bulge is at least partially embedded in the first recess to form a structure in which the electrode plate engages with the tab, thereby increasing connection strength between the tab and the electrode plate, and increasing tensile strength of the electrode plate assembly. At the same time, compared with an electrode plate assembly in which the first surface of the electrode plate is planar and a surface, opposite to the electrode plate, of the tab is planar, this technical solution lets the first bulge be at least partially embedded in the first recess, thereby increasing the contact area between the tab and the electrode plate, and improving the conductivity between the tab and the electrode plate. This also reduces a risk that, during use of the battery cell, a stress generated by expansion of the electrode plate acts on a junction between the tab and the electrode plate, causes mechanical fatigue at the junction between the tab and the electrode plate, and results in failure of connection between the tab and the electrode plate, thereby improving reliability of the battery cell in use.

In some embodiments, a plurality of the first bulges are disposed on the tab. A plurality of the first recesses are disposed on the first surface. The plurality of the first bulges correspond to the plurality of the first recesses one to one. The increased number of the first bulges and the first recesses can further improve the conductivity and connection strength of the tab and the electrode plate.

In some embodiments, a total area of projections of the plurality of the first bulges in the thickness direction of the electrode plate is S₁, and an overlap area between the tab and the electrode plate is S₂, satisfying:

$$\frac{{s}_{1}}{{s}_{2}} \geq 20 \% .$$

The ratio of the total area of projections of the plurality of first bulges in the thickness direction of the electrode plate to the overlap area between the tab and the electrode plate is set to fall within a reasonable range, thereby reducing the risk of insufficient strength of the tab caused by the excessive number of the first bulges on the one hand, and, on the other hand, reducing the risk of insufficient connection strength between the tab and the electrode plate caused by insufficient first bulges.

In some embodiments, a radius of a circumcircle of a projection of the first bulge along the thickness direction of the electrode plate is D, and a distance between two adjacent first bulges is L, satisfying: D≤L≤3D. The distance between two adjacent first bulges is set to fall within a reasonable range, thereby reducing the risk of insufficient strength of the tab caused by the excessive number of the first bulges per unit area due to L being less than D on the one hand, and, on the other hand, reducing the risk of insufficient connection strength between the tab and the electrode plate caused by insufficient first bulges per unit area due to L being greater than 3D.

In some embodiments, a radius of a circumcircle of a projection of the first bulge along the thickness direction of the electrode plate is D, satisfying: 0.2 mm≤D≤5 mm. The radius of the circumcircle of the projection of the first bulge along the thickness direction of the electrode plate is set to fall within a reasonable range, thereby reducing the risk of insufficient connection strength between the tab and the electrode plate caused by a small contact area between the tab and the electrode plate due to D being less than 0.2 mm on the one hand, and, on the other hand, reducing the risk of insufficient strength of the tab due to D being greater than 5 mm.

In some embodiments, a radius of a circumcircle of a projection of the first bulge along the thickness direction of the electrode plate is D, satisfying: 0.5 mm≤D≤2 mm. The radius of the circumcircle of the projection of the first bulge along the thickness direction of the electrode plate is set to fall within a reasonable range, thereby reducing the risk of insufficient connection strength between the tab and the electrode plate caused by a small contact area between the tab and the electrode plate due to D being less than 0.5 mm on the one hand, and, on the other hand, reducing the risk of insufficient strength of the tab due to D being greater than 2 mm.

In some embodiments, the tab includes a third surface oriented toward the first surface. The first bulge is disposed protrusively on the third surface. A protruding height of the first bulge that protrudes from the third surface is H₁, and a thickness of the electrode plate is H₂, satisfying: H₁<H₂. Such a design can reduce the risk that, when the electrode plate and the tab are press-bonded, the protruding height of the first bulge that protrudes from the third surface is greater than the thickness of the electrode plate, and the first bulge pierces the electrode plate and causes scrapping of the electrode plate due to insufficient plastic deformability of the electrode plate.

In some embodiments, 0.2 mm≤H₁≤5 mm. The protruding height of the first bulge that protrudes from the third surface is set to fall within a reasonable range, thereby reducing the risk of insufficient connection strength between the tab and the electrode plate caused by a small contact area between the tab and the electrode plate due to H₁ being less than 0.2 mm on the one hand, and, on the other hand, reducing the risk of an insufficient energy density of the battery cell caused by an excessive total thickness of the electrode plate assembly due to H₁ being greater than 5 mm. This setting also reduces the risk of high difficulty of rewinding the electrode plate assembly caused by an excessive total thickness of the electrode plate assembly due to H₁ being greater than 5 mm.

In some embodiments, 0.5 mm≤H₁≤2 mm. The protruding height of the first bulge that protrudes from the third surface is set to fall within a reasonable range, thereby reducing the risk of insufficient connection strength between the tab and the electrode plate caused by a small contact area between the tab and the electrode plate due to H₁ being less than 0.5 mm on the one hand, and, on the other hand, reducing the risk of an insufficient energy density of the battery cell caused by an excessive total thickness of the electrode plate assembly due to H₁ being greater than 2 mm. This setting also reduces the risk of high difficulty of rewinding the electrode plate assembly caused by an excessive total thickness of the electrode plate assembly due to H₁ being greater than 2 mm.

In some embodiments, the first bulge is hemispherical. Such a design makes it more convenient to process the first bulge. In addition, because the hemispherical first bulge includes a tip, the hemispherical first bulge is more easily embedded into the electrode plate in a process of press-bonding the electrode plate and the tab, so as to form a structure in which the first bulge engages with the first recess. In addition, with the volume being constant, the hemispherical structure is larger in surface area, thereby increasing the contact area between the electrode plate and the tab, and improving the conductivity between the electrode plate and the tab.

In some embodiments, the tab includes a third surface oriented toward the first surface and a fourth surface oriented away from the first surface. The first bulge is disposed protrusively on the third surface. A second recess is formed on the fourth surface at a position corresponding to the first bulge. With such a design, the tab can be processed by stamping or other means, thereby reducing the processing difficulty of forming the first bulge on the tab.

In some embodiments, a second bulge is formed on the second surface at a position corresponding to the first recess. With such a design, the electrode plate can be preprocessed by stamping or other means, thereby reducing the difficulty of engaging the first bulge with the first recess.

In some embodiments, a first through-hole penetrating the electrode plate along the thickness direction of the electrode plate is created on the electrode plate. The tab includes a main body and a riveting portion. The main body is disposed on the first surface. The riveting portion is disposed protrusively on the main body and runs through the first through-hole. One end, away from the main body, of the riveting portion presses against the second surface. More than being connected by welding, the tab may be connected to the electrode plate by a riveting portion, thereby diversifying the processing methods of the electrode plate assembly.

In some embodiments, the electrode plate includes a current collector and a first active material layer. At least a part of the first active material layer is located between the tab and the current collector. The first through-hole penetrates the current collector and the first active material layer. Compared with the connection implemented between the tab and the electrode plate by welding, the riveting portion can implement direct connection between the tab and the electrode plate without a need to avoid the active material layer, thereby improving the processing efficiency.

In some embodiments, the main body includes a second through-hole, and the second through-hole penetrates the riveting portion along the thickness direction of the electrode plate.

In some embodiments, the number of the riveting portions is plural, and the number of the first through-holes is plural. The plurality of the riveting portions correspond to the plurality of the first through-holes one to one. The plurality of riveting portions can further increase the connection strength between the electrode plate and the tab.

According to a second aspect, this application provides a battery cell. The battery cell includes a shell and the electrode plate assembly disclosed in the above embodiment. The electrode plate assembly is accommodated in the shell.

According to a third aspect, this application provides an electrical device. The electrical device includes the battery cell disclosed in the above embodiment.

The foregoing description is merely an overview of the technical solutions of this application. Some specific embodiments of this application are described below illustratively to enable a clearer understanding of the technical solutions of this application, enable implementation of the technical solutions based on the subject-matter hereof, and make the foregoing and other objectives, features, and advantages of this application more evident and comprehensible.

### BRIEF DESCRIPTION OF DRAWINGS

By reading the following detailed description of exemplary embodiments, a person of ordinary skill in the art becomes clearly aware of various other advantages and benefits. The drawings are merely intended to illustrate the exemplary embodiments, but not to limit this application. In all the drawings, the same reference numeral represents the same component. In the drawings:

FIG. 1 is an axonometric drawing of an electrode plate assembly according to some embodiments of this application;

FIG. 2 is a cross-sectional view of an electrode plate assembly according to some embodiments of this application;

FIG. 3 is a cross-sectional view of a tab according to some embodiments of this application;

FIG. 4 is a cross-sectional view of an electrode plate assembly according to some other embodiments of this application;

FIG. 5 is a cross-sectional view of an electrode plate assembly according to still some other embodiments of this application;

FIG. 6 is a cross-sectional view of an electrode plate assembly according to yet some embodiments of this application;

FIG. 7 is a cross-sectional view of an electrode plate according to some embodiments of this application;

FIG. 8 is a cross-sectional view of an electrode plate assembly according to some embodiments of this application, in which a position of a first active material layer is shown;

FIG. 9 is a top view of a tab according to some embodiments of this application; and

FIG. 10 is a top view of an electrode plate according to some embodiments of this application.

### LIST OF REFERENCE NUMERALS

100—electrode plate assembly; 10—electrode plate; 101—first surface; 1011—first recess; 102—second surface; 1021—second bulge; 1010—current collector; 1020—first active material layer; 1030—first through-hole; 20—tab; 201—third surface; 2010—main body; 2020—riveting portion; 20101—second through-hole; 2011—first bulge; 202—fourth surface; 2021—second recess; 30—tab adhesive.

### DETAILED DESCRIPTION

Some embodiments of the technical solutions of this application are described in detail below with reference to the drawings. The following embodiments are merely intended as examples to describe the technical solutions of this application more clearly, but not intended to limit the protection scope of this application.

Unless otherwise defined, all technical and scientific terms used herein bear the same meanings as what is normally understood by a person skilled in the technical field of this application. The terms used herein are merely intended to describe specific embodiments but not to limit this application. The terms “include” and “contain” and any variations thereof used in the specification, claims, and brief description of drawings of this application are intended as non-exclusive inclusion.

In the description of some embodiments of this application, the technical terms “first” and “second” are merely intended to distinguish between different items but not intended to indicate or imply relative importance or implicitly specify the number of the indicated technical features, specific order, or order of precedence. In the description of some embodiments of this application, unless otherwise expressly specified, “a plurality of” means two or more.

Reference to an “embodiment” herein means that a specific feature, structure or characteristic described with reference to this embodiment may be included in at least one embodiment of this application. Reference to this term in different places in the specification does not necessarily represent the same embodiment, nor does it represent an independent or alternative embodiment in a mutually exclusive relationship with other embodiments. A person skilled in the art explicitly and implicitly understands that the embodiments described herein may be combined with other embodiments.

In the description of embodiments of this application, the term “a plurality of” means two or more (including two). Similarly, “a plurality of groups” means two or more groups (including two groups), and “a plurality of pieces” means two or more pieces (including two pieces).

In the description of embodiments of this application, a direction or a positional relationship indicated by the terms such as “center”, “longitudinal”, “transverse”, “length”, “width”, “thickness”, “up”, “down”, “before”, “after”, “left”, “right”, “vertical”, “horizontal”, “top”, “bottom”, “in”, “out”, “clockwise”, “counterclockwise”, “axial”, “radial”, and “circumferential” is a direction or positional relationship based on the illustration in the drawings, and is merely intended for ease or brevity of description of embodiments of this application, but not intended to indicate or imply that the indicated device or component is necessarily located in the specified direction or constructed or operated in the specified direction. Therefore, such terms are not to be understood as a limitation on embodiments of this application.

In the description of this application, unless otherwise expressly specified and defined, the technical terms such as “mount”, “concatenate”, “connect”, and “fix” are generic in a broad sense, for example, mean a fixed connection, a detachable connection, or a one-piece configuration; or mean a mechanical connection or an electrical connection; or mean a direct connection or an indirect connection implemented through an intermediary; or mean internal communication between two components or interaction between two components. A person of ordinary skill in the art can understand the specific meanings of the terms in some embodiments of this application according to specific situations.

Currently, the market trend shows that battery cells are applied more extensively. The battery cells are widely applied to electric means of transport such as electric bicycles, electric motorcycles, and electric vehicles, and in many other fields such as electric tools, unmanned aerial vehicles, and energy storage devices. The market demand for battery cells keeps soaring with the widening of the application fields of the battery cells.

The development of the battery cells needs to consider many factors, including performance parameters such as energy density, cycle life, discharge capacity, charge rate, and discharge rate, and also needs to consider reliability of the battery cells in use.

The battery cell generally includes a shell, an electrode assembly, a separator, a positive tab, and a negative tab. The electrode assembly includes a positive electrode plate, a negative electrode plate, and a separator. The battery cell works primarily by shuttling metal ions between the positive electrode plate and the negative electrode plate. The positive electrode plate and the negative electrode plate are collectively referred to as electrode plates. In order to lead out the electrical energy of the electrode assembly, the positive tab generally needs to be electrically connected to the positive electrode plate, and the negative tab generally needs to be electrically connected to the negative electrode plate. The positive tab and the negative tab are collectively referred to as tabs. The component formed by electrically connecting the tab to the electrode plate may be referred to as an electrode plate assembly.

Generally, the electrode plate assembly is formed of the tab and the electrode plate connected by welding or other means. Alternatively, the electrode plate assembly is formed by bonding the tab to the electrode plate by applying conductive adhesive glue onto the opposite sides of the tab and the electrode plate. In an example in which the electrode plate assembly is formed by welding, in welding the tab to the electrode plate, a straight surface of the electrode plate is generally connected to a straight surface of the tab first, and then the tab is welded to the electrode plate by using a resistance welder, an ultrasonic welder, a laser welder, or another device, so as to form an electrode plate assembly. Because the connection between the tab and the electrode plate is implemented by merely point-shaped weld joints formed by welding, the connection strength is not high. When a stress or external force generated by the expansion of the battery cell acts repeatedly on the junction between the tab and the electrode plate, the junction between the tab and the electrode plate is prone to mechanical fatigue. Especially, when the electrode plate assembly is subjected to tension, the junction between the tab and the electrode plate is prone to break off. After the connection between the tab and the electrode plate fails, the electrical energy of the electrode assembly is unable to be led out, thereby causing the battery cell to be out of service. Because the outer shell of a pouch cell is a soft housing, such as an aluminum laminated film or a packaging bag, the deformation resistance of the battery cell is relatively low. Therefore, the connection strength between the tab and the electrode plate of the pouch cell more significantly affects the reliability of the battery cell in use.

In view of the situation above, this application provides an electrode plate assembly. The electrode plate assembly includes an electrode plate and a tab. The electrode plate includes a first surface and a second surface that are disposed opposite to each other along a thickness direction of the electrode plate. The tab is disposed on the first surface and electrically connected to the electrode plate. A first bulge is disposed on the tab. A first recess is disposed on the first surface. The first bulge is at least partially embedded into the first recess. The first bulge is at least partially embedded in the first recess to form a structure in which the electrode plate engages with the tab, thereby increasing connection strength between the tab and the electrode plate, and increasing tensile strength of the electrode plate assembly. At the same time, compared with an electrode plate assembly in which the first surface of the electrode plate is planar and a surface, opposite to the electrode plate, of the tab is planar, this technical solution lets the first bulge be at least partially embedded in the first recess, thereby increasing the contact area between the tab and the electrode plate, and improving the conductivity between the tab and the electrode plate. This also reduces a risk that, during use of the battery cell, a stress generated by expansion of the electrode plate acts on a junction between the tab and the electrode plate, causes mechanical fatigue at the junction between the tab and the electrode plate, and results in failure of connection between the tab and the electrode plate, thereby improving reliability of the battery cell in use.

The battery cell disclosed in this embodiment of this application is applicable to, but not limited to use in, an electrical device such as an electric bicycle, an electric tool, an unmanned aerial vehicle, and an energy storage device. A battery cell compliant with the working conditions specified in this application may be used as a power supply system of an electrical device to improve the reliability of the battery cell and the reliability of the electrical device.

An embodiment of this application provides an electrical device that uses a battery cell as a power supply. The electrical device may be, but is not limited to, an electronic device, an electric tool, an electric means of transport, an unmanned aerial vehicle, or an energy storage device. The electronic device may be a mobile phone, a tablet computer, a laptop computer, or the like. The electric tool may be an electric drill, an electric chainsaw, or the like. The electric means of transport may be an electric vehicle, an electric motorcycle, an electric bicycles, or the like.

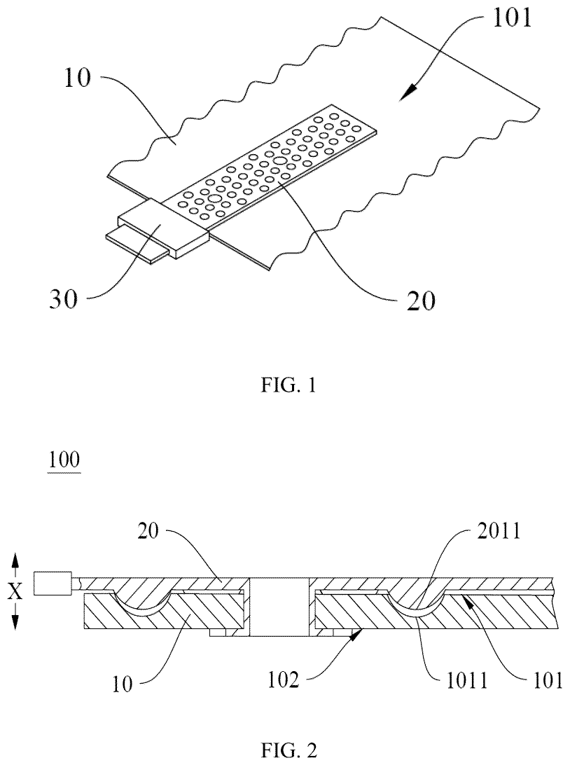

According to some embodiments of this application, referring to FIG. 1 and FIG. 2, this application provides an electrode plate assembly 100. The electrode plate assembly 100 includes an electrode plate 10 and a tab 20. The electrode plate 10 includes a first surface 101 and a second surface 102 that are disposed opposite to each other along a thickness direction of the electrode plate. The tab 20 is disposed on the first surface 101 and electrically connected to the electrode plate 10. A first bulge 2011 is disposed on the tab 20. A first recess 1011 is disposed on the first surface 101 and recessed toward the second surface 102. The first recess 1011 does not penetrate the second surface 102. The first bulge 2011 is at least partially embedded into the first recess 1011.

The thickness direction of the electrode plate 10 is the direction X shown in FIG. 2.

The shapes of the first bulge 2011 may include, but are not limited to, a hemisphere, a cuboid, a pyramid, a prism, a cylinder, or the like.

The shapes of the first recess 1011 may include, but are not limited to, a hemisphere, a cuboid, a pyramid, a prism, a cylinder, or the like.

The number of first bulges 2011 may be plural.

The tab 20 may be electrically connected to the electrode plate 10 by welding, riveting, other means. The tab 20 may be bonded and electrically connected to the electrode plate 10 by conductive adhesive. Alternatively, the tab 20 may be interlocked and electrically connected to the electrode plate 10 by a fastener (such as a bolt and a screw that mate with each other).

The first bulge 2011 is at least partially embedded in the first recess 1011, which means that the outer surface of the first bulge 2011 at least partially fits the inner surface of the first recess 1011 snugly.

In some embodiments, the tab 20 may be processed by rolling or stamping to form a first bulge 2011 on the tab 20. Subsequently, the electrode plate 10 is processed by rolling or stamping to form a first recess 1011 on the first surface 101 of the electrode plate 10. Afterward, at least a part of the first bulge 2011 is embedded into the first recess 1011 by press-bonding. Finally, the tab 20 is electrically connected to the electrode plate 10 by welding or riveting.

In some embodiments, the tab 20 may be processed by rolling or stamping to form a first bulge 2011 on the tab 20. Subsequently, the tab 20 and the electrode plate 10 are press-bonded so that the first surface 101 of the electrode plate 10 is squeezed by the first bulge 2011 to deform plastically and form a first recess 1011. The first bulge 2011 is at least partially embedded into the first recess 1011. Finally, the tab 20 is electrically connected to the electrode plate 10 by welding or riveting.

In some embodiments, the first bulge 2011 may be formed on the tab 20 by a preset mold, and the first recess 1011 may be formed on the electrode plate 10 by a mold.

In some embodiments, the electrode plate 10 includes a substrate. The substrate includes a coated region and a blank foil region. The coated region is coated with an active material. The blank foil region is not coated with the active material. In the thickness direction of the electrode plate 10, the projection of the tab 20 is located in the blank foil region.

In some embodiments, the electrode plate 10 includes a substrate. A surface, oriented toward the tab 20, of the substrate is coated with an active material. The tab 20 is riveted to the electrode plate 10. For example, the tab 20 may be riveted to the electrode plate 10 by passing a rivet through the tab 20 and the electrode plate 10.

In some embodiments, the electrode plate 10 includes a substrate. Both the surface, oriented toward the tab 20, of the substrate and the surface, oriented away from the tab 20, of the substrate are coated with the active material.

In some embodiments, the electrode plate 10 includes a first edge in a width direction of the electrode plate. A tab adhesive 30 is disposed on a part of the tab 20, the part extending beyond the first edge. The tab adhesive 30 is configured to seal the packaging bag and the tab 20.

The electrode plate 10 may be a positive electrode plate or a negative electrode plate. In some embodiments, the positive electrode plate, the negative electrode plate, and the separator are wound together to form an electrode assembly. In some embodiments, the positive electrode plate, the negative electrode plate, and the separator are stacked up to form an electrode assembly.

According to some embodiments of this application, referring to FIG. 1 and FIG. 2, a plurality of the first bulges 2011 are disposed on the tab 20. A plurality of the first recesses 1011 are disposed on the first surface 101. The plurality of the first bulges 2011 correspond to the plurality of the first recesses 1011 one to one.

The plurality of first bulges 2011 may be spaced apart along the width direction of the electrode plate 10 and/or spaced apart along the length direction of the electrode plate 10. In some embodiments, a hole configured to rivet the tab 20 and the electrode plate 10 together is created on the electrode plate 10. A plurality of first bulges 2011 may be arranged at intervals around the hole.

The increased number of the first bulges 2011 and the first recesses 1011 can further improve the conductivity and connection strength of the tab 20 and the electrode plate 10.

According to some embodiments of this application, a total area of projections of the plurality of the first bulges 2011 in the thickness direction of the electrode plate 10 is S₁, and an overlap area between the tab 20 and the electrode plate 10 is S₂, satisfying:

$$\frac{{s}_{1}}{{s}_{2}} \geq 20 \% .$$

In order to increase the energy density of the battery cell, the tab 20 is generally thin. Processing the first bulge 2011 on the thin tab 20 impairs the structural strength of the tab 20 to some extent.

First, an image of the tab 20 may be acquired in the thickness direction of the electrode plate 10, and a contour of the image is extracted and screened to obtain coordinates of the contour of the first bulge 2011, and then the area S₁ of the contour of the first bulge 2011 is calculated. Next, an image of the electrode plate assembly 100 may be acquired in the thickness direction of the electrode plate 10, and a contour of the image is extracted and screened to calculate coordinates of a contour of the non-overlapping part between the tab 20 and the electrode plate 10, and the area of the non-overlapping part between the tab 20 and the electrode plate 10 is calculated. The overlap area S₂ between the tab 20 and the electrode plate 10 is obtained by subtracting the area of the contour of the non-overlapping part between the tab 20 and the electrode plate 10 from the total area of the electrode plate 10, and then a ratio of S₁ to S₂ is calculated.

The ratio of the total area of projections of the plurality of first bulges 2011 in the thickness direction of the electrode plate 10 to the overlap area between the tab 20 and the electrode plate 10 is set to fall within a reasonable range, thereby reducing the risk of insufficient strength of the tab 20 caused by the excessive number of the first bulges 2011 on the one hand, and, on the other hand, reducing the risk of insufficient connection strength between the tab 20 and the electrode plate 10 caused by insufficient first bulges 2011.

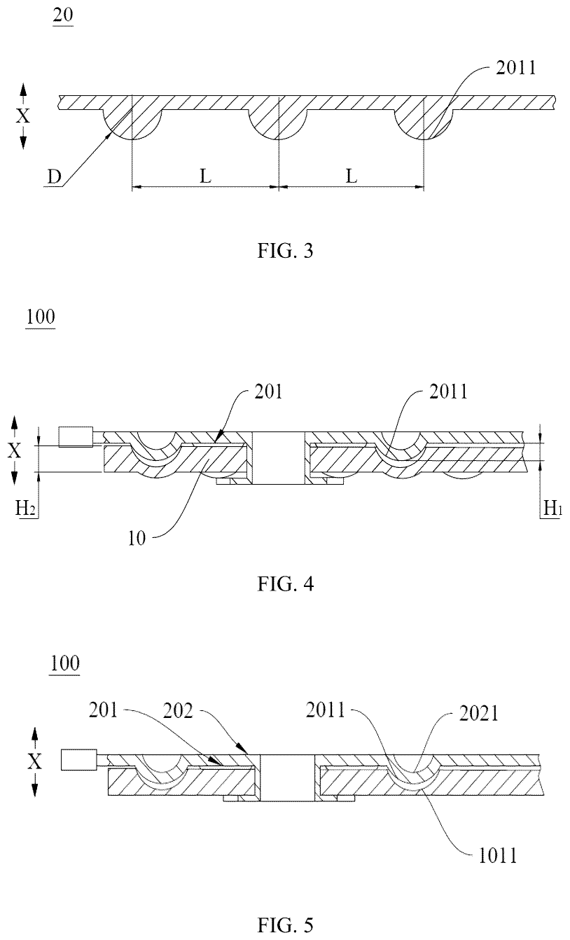

According to some embodiments of this application, referring to FIG. 3 and FIG. 4, a radius of a circumcircle of a projection of the first bulge 2011 along the thickness direction of the electrode plate is D, and a distance between two adjacent first bulges 2011 is L, satisfying: D≤L≤3D.

In an embodiment in which the first bulges 2011 are hemispherical, the radius of the circumcircle of a projection of the first bulge 2011 along the thickness direction of the electrode plate is D, and D is the radius of the hemisphere.

The projection of the first bulges 2011 along the thickness direction of the electrode plate is a shape that is symmetrical to some extent, such as a circle, a rectangle, a parallelogram, or the like. D is the dimension of the first bulge 2011 on a line that connects the geometric centers of two adjacent first bulges 2011.

When the shape of the projection of the first bulge 2011 along the thickness direction of the electrode plate is irregular, D is a radius of a minimum circle that can surround the projection of the first bulge 2011 along the thickness direction of the electrode plate.

In an example in which a plurality of first bulges 2011 are disposed in the width direction of the electrode plate 10, the distance L between two adjacent first bulges 2011 may be understood as a half of a sum of a maximum distance and a minimum distance between the two adjacent first bulges 2011 in the width direction of the electrode plate 10. In an embodiment in which the first bulge 2011 is hemispherical, the distance L between two adjacent first bulges 2011 is a distance between two adjacent sphere centers.

The distance between two adjacent first bulges 2011 is set to fall within a reasonable range, thereby reducing the risk of insufficient strength of the tab 20 caused by the excessive number of the first bulges 2011 per unit area due to L being less than D on the one hand, and, on the other hand, reducing the risk of insufficient connection strength between the tab 20 and the electrode plate 10 caused by insufficient first bulges 2011 per unit area due to L being greater than 3D.

According to some embodiments of this application, referring to FIG. 3 and FIG. 4, a radius of a circumcircle of a projection of the first bulge 2011 along the thickness direction of the electrode plate 10 is D, satisfying: 0.2 mm≤D≤5 mm.

The radius of the circumcircle of the projection of the first bulge 2011 along the thickness direction of the electrode plate 10 may be any value greater than or equal to 0.2 mm and less than or equal to 5 mm, for example, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm m, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, or 5 mm.

The radius of the circumcircle of the projection of the first bulge 2011 along the thickness direction of the electrode plate 10 is D, satisfying: 0.2 mm≤D≤5 mm. The radius of the circumcircle of the projection of the first bulge 2011 along the thickness direction of the electrode plate 10 is set to fall within a reasonable range, thereby reducing the risk of insufficient connection strength between the tab 20 and the electrode plate 10 caused by a small contact area between the tab 20 and the electrode plate 10 due to D being less than 0.2 mm on the one hand, and, on the other hand, reducing the risk of insufficient strength of the tab 20 due to D being greater than 5 mm.

According to some embodiments of this application, referring to FIG. 3 and FIG. 4, a radius of a circumcircle of a projection of the first bulge 2011 along the thickness direction of the electrode plate 10 is D, satisfying: 0.5 mm≤D≤2 mm.

The radius of the circumcircle of the projection of the first bulge 2011 along the thickness direction of the electrode plate 10 may be any value greater than or equal to 0.5 mm and less than or equal to 2 mm, for example, 0.5 mm, 0.55 mm, 0.6 mm, 0.65 mm, 0.7 mm, 0.75 mm, 0.8 mm, 0.85 mm, 0.9 mm, 0.95 mm, 1 mm, 1.05 mm, 1.1 mm, 1.15 mm, 1.2 mm, 1.25 mm, 1.3 mm, 1.35 mm, 1.4 mm, 1.45 mm, 1.5 mm, 1.55 mm, 1.6 mm, 1.65 mm, 1.7 mm, 1.75 mm, 1.8 mm, 1.85 mm, 1.9 mm, 1.95 mm, or 2 mm.

The radius of the circumcircle of the projection of the first bulge 2011 along the thickness direction of the electrode plate 10 is set to fall within a reasonable range, thereby reducing the risk of insufficient connection strength between the tab 20 and the electrode plate 10 caused by a small contact area between the tab 20 and the electrode plate 10 due to D being less than 0.5 mm on the one hand, and, on the other hand, reducing the risk of insufficient strength of the tab 20 due to D being greater than 2 mm.

According to some embodiments of this application, referring to FIG. 4, the tab 20 includes a third surface 201 oriented toward the first surface 101. The first bulge 2011 is disposed protrusively on the third surface 201. A protruding height of the first bulge 2011 that protrudes from the third surface 201 is H₁, and a thickness of the electrode plate 10 is H₂, satisfying: H₁<H₂.

In a process of press-bonding the electrode plate 10 and the tab 20 together, a maximum penetration depth of the first bulge 2011 that extends into the electrode plate 10 is the protruding height of the first bulge 2011 that protrudes from the third surface 201.

Such a design can reduce the risk that, when the electrode plate 10 and the tab 20 are press-bonded, the protruding height of the first bulge 2011 that protrudes from the third surface 201 is greater than the thickness of the electrode plate 10, and the first bulge 2011 pierces the electrode plate 10 and causes scrapping of the electrode plate 10 due to insufficient plastic deformability of the electrode plate 10 after the electrode plate 10 and the tab 20 are press-bonded together.

According to some embodiments of this application, referring to FIG. 4, 0.2 mm≤H₁≤5 mm.

The protruding height of the first bulge 2011 that protrudes from the third surface 201 may be any value greater than or equal to 0.2 mm and less than or equal to 5 mm, for example, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm m, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, or 5 mm.

The protruding height of the first bulge 2011 that protrudes from the third surface 201 is set to fall within a reasonable range, thereby reducing the risk of insufficient connection strength between the tab 20 and the electrode plate 10 caused by a small contact area between the tab 20 and the electrode plate 10 due to H₁ being less than 0.2 mm on the one hand, and, on the other hand, reducing the risk of an insufficient energy density of the battery cell caused by an excessive total thickness of the electrode plate assembly 100 due to H₁ being greater than 5 mm. This setting also reduces the risk of high difficulty of rewinding the electrode plate assembly 100 caused by an excessive total thickness of the electrode plate assembly 100 due to H₁ being greater than 5 mm.

According to some embodiments of this application, referring to FIG. 4, 0.5 mm≤H₁≤2 mm.

The protruding height H₁ of the first bulge 2011 that protrudes from the third surface 201 may be any value greater than or equal to 0.5 mm and less than or equal to 2 mm, for example, 0.5 mm, 0.55 mm, 0.6 mm, 0.65 mm, 0.7 mm, 0.75 mm, 0.8 mm, 0.85 mm, 0.9 mm, 0.95 mm, 1 mm, 1.05 mm, 1.1 mm, 1.15 mm, 1.2 mm, 1.25 mm, 1.3 mm, 1.35 mm, 1.4 mm, 1.45 mm, 1.5 mm, 1.55 mm, 1.6 mm, 1.65 mm, 1.7 mm, 1.75 mm, 1.8 mm, 1.85 mm, 1.9 mm, 1.95 mm, or 2 mm.

The protruding height of the first bulge 2011 that protrudes from the third surface 201 is set to fall within a reasonable range, thereby reducing the risk of insufficient connection strength between the tab 20 and the electrode plate 10 caused by a small contact area between the tab 20 and the electrode plate 10 due to H₁ being less than 0.5 mm on the one hand, and, on the other hand, reducing the risk of an insufficient energy density of the battery cell caused by an excessive total thickness of the electrode plate assembly 100 due to H₁ being greater than 2 mm. This setting also reduces the risk of high difficulty of rewinding the electrode plate assembly 100 caused by an excessive total thickness of the electrode plate assembly 100 due to H₁ being greater than 2 mm.

According to some embodiments of this application, referring to FIG. 4, the first bulge 2011 is hemispherical.

The first bulge 2011 may be a solid hemisphere or a hollow hemisphere.

Such a design makes it more convenient to process the first bulge 2011. In addition, because the hemispherical first bulge 2011 includes a tip, the hemispherical first bulge 2011 is more easily embedded into the electrode plate 10 in a process of press-bonding the electrode plate 10 and the tab 20 to form a structure in which the first bulge 2011 engages with the first recess 1011. In addition, with the volume being constant, the hemispherical structure is larger in surface area, thereby increasing the contact area between the electrode plate 10 and the tab 20, and improving the conductivity between the electrode plate 10 and the tab 20.

According to some embodiments of this application, referring to FIG. 5, the tab 20 includes a third surface 201 oriented toward the first surface 101 and a fourth surface 202 oriented away from the first surface 101. The first bulge 2011 is disposed protrusively on the third surface 201. A second recess 2021 is formed on the fourth surface 202 at a position corresponding to the first bulge 2011.

When the tab 20 is processed by rolling or stamping, a second recess 2021 is formed on the fourth surface 202 of the tab 20 at a position corresponding to the first bulge 2011 at the same time as a first bulge 2011 is formed on the third surface 201 of the tab 20.

Alternatively, the first bulge 2011 and the second recess 2021 may be formed simultaneously by using a mold.

With such a design, the tab 20 can be processed by stamping or other means, thereby reducing the processing difficulty of forming the first bulge 2011 on the tab 20.

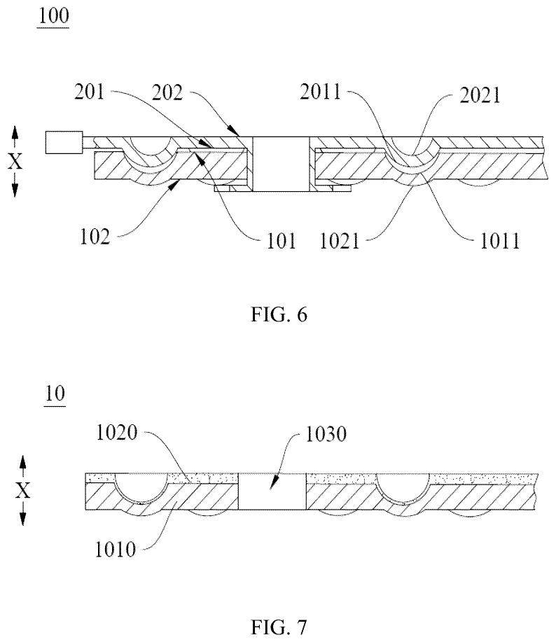

According to some embodiments of this application, referring to FIG. 6, a second bulge 1021 is formed on the second surface 102 at a position corresponding to the first recess 1011.

When the electrode plate 10 is processed by rolling or stamping, a second bulge 1021 is formed on the second surface 102 of the electrode plate 10 at a position corresponding to the first recess 1011 at the same time as a first recess 1011 is formed on the first surface 101 of the electrode plate 10.

Alternatively, the first recess 1011 and the second bulge 1021 may be formed simultaneously by using a mold.

With such a design, the electrode plate 10 can be preprocessed by stamping or other means, thereby reducing the difficulty of engaging the first bulge 2011 with the first recess 1011.

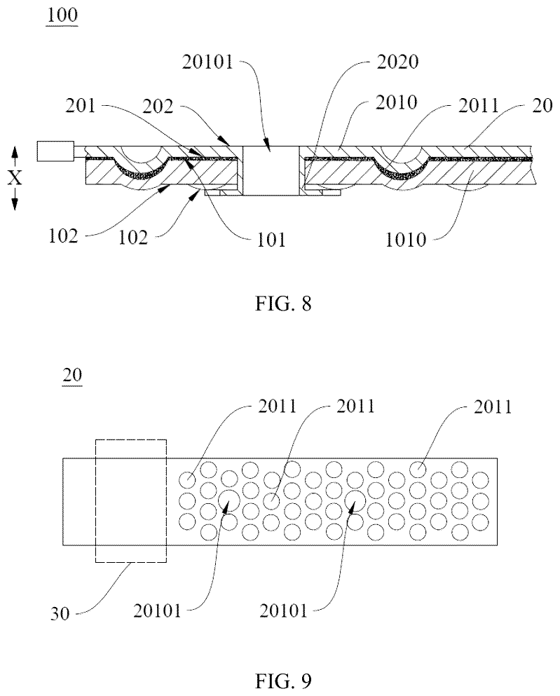

According to some embodiments of this application, referring to FIG. 7 and FIG. 8, a first through-hole 1030 penetrating the electrode plate along the thickness direction of the electrode plate is created on the electrode plate 10. The tab 20 includes a main body 2010 and a riveting portion 2020. The main body 2010 is disposed on the first surface 101. The riveting portion 2020 is disposed protrusively on the main body 2010 and runs through the first through-hole 1030. One end, away from the main body 2010, of the riveting portion 2020 presses against the second surface 102.

“Pressing against” means that one component is in direct or indirect contact with another component, and an interaction force may be exerted between the two components or not. For example, “the riveting portion 2020 presses against the second surface 102” means that the riveting portion 2020 is in direct or indirect contact with the second surface 102, and an interaction force may be exerted between the riveting portion 2020 and the second surface 102 or not.

The first through-hole 1030 may be a circular hole, a square hole, or a special-shaped hole (such as a cross-shaped hole).

The riveting portion 2020 can reduce the risk of relative displacement between the electrode plate 10 and the tab 20.

In some embodiments, the electrode plate 10 includes a current collector 1010. A first active material layer 1020 is disposed on one side of the current collector 1010, the side being oriented toward the tab 20. The first through-hole 1030 penetrates the current collector 1010 and the first active material layer 1020. In some embodiments, a first active material layer 1020 is disposed on one side of the current collector 1010, the side being oriented toward the tab 20, and a second active material layer is applied on one side of the current collector 1010, the side being oriented away from the tab 20. The first through-hole 1030 penetrates the current collector 1010, the first active material layer 1020, and the second active material layer.

A first through-hole 1030 is pre-processed on the electrode plate 10. The tab 20 laps the electrode plate 10, and is placed at a punching position of a punching mechanism. The tab 20 is pierced by using a punching pin. The punching pin passes through the electrode plate 10 along the first through-hole 1030. The pierced part of the tab 20 passes through the first through-hole 1030 and is folded to one side of the electrode plate 10, the side being oriented away from the tab 20. The folded part is flattened by using a pressing block, thereby implementing electrical connection between the electrode plate 10 and the tab 20. The riveting portion 2020 is the part, pierced by the punching pin, of the tab 20.

More than being connected by welding, the tab 20 may be connected to the electrode plate 10 by a riveting portion 2020, thereby diversifying the processing methods of the electrode plate assembly 100.

According to some embodiments of this application, referring to FIG. 7 and FIG. 8, the electrode plate 10 includes a current collector 1010 and a first active material layer 1020. At least a part of the first active material layer 1020 is located between the tab 20 and the current collector 1010. The first through-hole 1030 penetrates the current collector 1010 and the first active material layer 1020.

The positive current collector includes two surfaces opposite to each other in a thickness direction of the current collector. The positive active material layer may be disposed on one or both of the two opposite surfaces of the positive current collector. The positive current collector may be metal foil or a composite current collector. For example, the metal foil may be made of silver-plated aluminum, silver-plated stainless steel, stainless steel, copper, aluminum, nickel, carbon electrode, carbon, nickel, titanium, or the like. The composite current collector may include a polymer material substrate and a metal layer. The composite current collector may be formed by overlaying the polymer material substrate with a metal material (for example, aluminum, aluminum alloy, nickel, nickel alloy, titanium, titanium alloy, silver, and silver alloy). The polymer material substrate may be, for example, polypropylene, polyethylene terephthalate, polybutylene terephthalate, polystyrene, or polyethylene.

In some embodiments, the first active material layer 1020 may be a positive active material layer. The positive active material layer may include at least one of the following materials: lithium-containing phosphate salt, lithium transition metal oxide, or a modified compound thereof. However, this application is not limited to such materials, and other conventional materials usable as a positive active material of a battery cell may be used instead.

The negative current collector may be a metal foil or a composite current collector. For example, the metal foil may be made of silver-plated aluminum, silver-plated stainless steel, stainless steel, copper, aluminum, nickel, carbon electrode, carbon, nickel, titanium, or the like. The negative current collector includes two surfaces opposite to each other in a thickness direction of the negative current collector. The negative active material layer is disposed on either or both of the two opposite surfaces of the negative current collector.

In some embodiments, the first active material layer 1020 may be a negative active material layer. The negative active material layer may be a negative active material well-known for use in a battery cell in the art. As an example, the negative active material may include at least one of the following materials: artificial graphite, natural graphite, soft carbon, hard carbon, silicon-based material, tin-based material, lithium titanium oxide, and the like. The silicon-based material may be at least one selected from elemental silicon, a silicon-oxygen compound, a silicon-carbon composite, a silicon-nitrogen composite, and a silicon alloy. The tin-based material may be at least one selected from elemental tin, a tin-oxygen compound, or a tin alloy. However, this application is not limited to such materials, and other conventional materials usable as a negative active material of a battery cell may be used instead. One of the negative active materials may be used alone, or at least two thereof may be used in combination.

Compared with the connection implemented between the tab 20 and the electrode plate 10 by welding, the riveting portion 2020 can implement direct connection between the tab 20 and the electrode plate 10 without a need to avoid the active material layer, thereby improving the processing efficiency.

According to some embodiments of this application, referring to FIG. 8, the main body 2010 includes a second through-hole 20101. The second through-hole 20101 penetrates the riveting portion 2020 along the thickness direction of the electrode plate 10.

The second through-hole 20101 is a through-hole formed by a punching pin piercing the tab 20. In other words, after the punching pin pierces the tab 20 and passes through the first through-hole 1030, the main body 2010 forms a second through-hole 20101 that matches the contour of the punching pin.

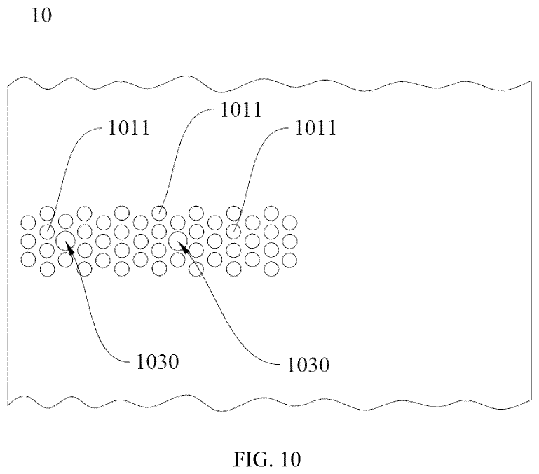

According to some embodiments of this application, referring to FIG. 8 to FIG. 10, the number of the riveting portions 2020 is plural, and the number of the first through-holes 1030 is plural. The plurality of the riveting portions 2020 correspond to the plurality of the first through-holes 1030 one to one.

In some embodiments, a plurality of riveting portions 2020 are spaced apart along the width direction of the electrode plate 10. The plurality of riveting portions 2020 can restrict the rotational freedom of the tab 20.

The plurality of riveting portions 2020 can further increase the connection strength between the electrode plate 10 and the tab 20.

According to some embodiments of this application, this application further provides a battery cell. The battery cell includes a shell and the electrode plate assembly 100 disclosed in any one of the above technical solutions. The electrode plate assembly 100 is accommodated in the shell.

According to some embodiments of this application, this application further provides an electrical device. The electrical device includes the battery cell disclosed in any one of the above technical solutions.

According to some embodiments of this application, referring to FIG. 1 and FIG. 6 to FIG. 10, this application provides an electrode plate assembly 100. The electrode plate assembly 100 includes an electrode plate 10 and a tab 20. The electrode plate 10 includes a first surface 101 and a second surface 102 that are disposed opposite to each other along a thickness direction of the electrode plate. The tab 20 is disposed on the first surface 101 and electrically connected to the electrode plate 10. A first bulge 2011 is disposed on the tab 20. A first recess 1011 is disposed on the first surface 101. The first bulge 2011 is at least partially embedded into the first recess 1011. The first bulge 2011 is hemispherical.

The tab 20 includes a third surface 201 oriented toward the first surface 101 and a fourth surface 202 oriented away from the first surface 101. The first bulge 2011 is disposed protrusively on the third surface 201. A second recess 2021 is formed on the fourth surface 202 at a position corresponding to the first bulge 2011. A second bulge 1021 is formed on the second surface 102 at a position corresponding to the first recess 1011.

A plurality of the first bulges 2011 are disposed on the tab 20. A plurality of the first recesses 1011 are disposed on the first surface 101. The plurality of the first bulges 2011 correspond to the plurality of the first recesses 1011 one to one.

A first through-hole 1030 penetrating the electrode plate along the thickness direction of the electrode plate is created on the electrode plate 10. The tab 20 includes a main body 2010 and a riveting portion 2020. The main body 2010 is disposed on the first surface 101. The riveting portion 2020 is disposed protrusively on the main body 2010 and runs through the first through-hole 1030. One end, away from the main body 2010, of the riveting portion 2020 presses against the second surface 102. The electrode plate 10 includes a current collector 1010 and a first active material layer 1020. At least a part of the first active material layer 1020 is located between the tab 20 and the current collector 1010. The first through-hole 1030 penetrates the current collector 1010 and the first active material layer 1020. The main body 2010 includes a second through-hole 20101. The riveting portion 2020 is disposed around the second through-hole 20101. The number of the riveting portions 2020 is plural, and the number of the first through-holes 1030 is plural. The plurality of the riveting portions 2020 correspond to the plurality of the first through-holes 1030 one to one.

Referring to FIG. 8, due to the first bulge 2011 that is at least partially embedded in the first recess 1011, the electrode plate assembly 100 is more resistant to tensile deformation, the connection strength between the tab 20 and the electrode plate 10 is increased, and the reliability of the battery cell in use is improved.

Finally, it is hereby noted that the foregoing embodiments are merely intended to describe the technical solutions of this application but not to limit this application. Although this application has been described in detail with reference to the foregoing embodiments, a person of ordinary skill in the art understands that modifications may still be made to the technical solutions described in the foregoing embodiments, or equivalent replacements may still be made to some or all technical features in the technical solutions. Such modifications and equivalent replacements fall within the scope of the claims and specification hereof without making the essence of the corresponding technical solutions depart from the scope of the technical solutions of the embodiments of this application. Particularly, to the extent that no structural conflict exists, various technical features mentioned in different embodiments may be combined in any manner. This application is not limited to the specific embodiments disclosed herein, but includes all technical solutions falling within the scope of the claims.

What is claimed is:

1. An electrode plate assembly, comprising:
an electrode plate, comprising a first surface and a second surface disposed opposite to each other along a thickness direction of the electrode plate; and
a tab, disposed on the first surface, and electrically connected to the electrode plate; wherein
a first bulge is disposed on the tab; a first recess is disposed on the first surface and recessed toward the second surface, the first recess does not penetrate the second surface; and the first bulge is at least partially embedded into the first recess.

2. The electrode plate assembly according to claim 1, wherein, a plurality of first bulges are disposed on the tab, a plurality of the first recesses are disposed on the first surface, and the plurality of the first bulges correspond to the plurality of the first recesses one to one.

3. The electrode plate assembly according to claim 2, wherein, a total area of projections of the plurality of the first bulges in the thickness direction of the electrode plate is S₁, an overlap area between the tab and the electrode plate is S₂, and
$$\frac{{s}_{1}}{{s}_{2}} \geq 20 \% .$$

4. The electrode plate assembly according to claim 2, wherein, a radius of a circumcircle of a projection of the first bulge along the thickness direction of the electrode plate is D, a distance between two adjacent first bulges is L, and D≤L≤3D.

5. The electrode plate assembly according to claim 1, wherein, a radius of a circumcircle of a projection of the first bulge along the thickness direction of the electrode plate is D, and 0.2 mm≤D≤5 mm.

6. The electrode plate assembly according to claim 1, wherein a radius of a circumcircle of a projection of the first bulge along the thickness direction of the electrode plate is D, and 0.5 mm≤D≤2 mm.

7. The electrode plate assembly according to claim 1, wherein, the tab comprises a third surface oriented toward the first surface, the first bulge is disposed protrusively on the third surface, a protruding height of the first bulge that protrudes from the third surface is H₁, a thickness of the electrode plate is H₂, and H₁<H₂.

8. The electrode plate assembly according to claim 7, wherein 0.2 mm≤H₁≤5 mm.

9. The electrode plate assembly according to claim 7, wherein 0.5 mm≤H_{1≤2} mm.

10. The electrode plate assembly according to claim 1, wherein, the first bulge is hemispherical.

11. The electrode plate assembly according to claim 1, wherein, the tab comprises a third surface oriented toward the first surface and a fourth surface oriented away from the first surface, the first bulge is disposed protrusively on the third surface, and a second recess is formed on the fourth surface at a position corresponding to the first bulge.

12. The electrode plate assembly according to claim 1, wherein, a second bulge is formed on the second surface at a position corresponding to the first recess.

13. The electrode plate assembly according to claim 1, wherein, a first through-hole penetrating the electrode plate along the thickness direction of the electrode plate is provided on the electrode plate, the tab comprises a main body and a riveting portion, the main body is disposed on the first surface, the riveting portion is disposed protrusively on the main body and runs through the first through-hole; and one end of the riveting portion presses against the second surface, the one end of the riveting portion being facing away from the main body.

14. The electrode plate assembly according to claim 2, wherein, a first through-hole penetrating the electrode plate along the thickness direction of the electrode plate is provided on the electrode plate, the tab comprises a main body and a riveting portion, the main body is disposed on the first surface, the riveting portion is disposed protrusively on the main body and runs through the first through-hole; and one end of the riveting portion presses against the second surface, the one end of the riveting portion being facing away from the main body.

15. The electrode plate assembly according to claim 3, wherein, a first through-hole penetrating the electrode plate along the thickness direction of the electrode plate is provided on the electrode plate, the tab comprises a main body and a riveting portion, the main body is disposed on the first surface, the riveting portion is disposed protrusively on the main body and runs through the first through-hole; and one end of the riveting portion presses against the second surface, the one end of the riveting portion being facing away from the main body.

16. The electrode plate assembly according to claim 15, wherein, the electrode plate comprises a current collector and a first active material layer, at least a part of the first active material layer is located between the tab and the current collector, and the first through-hole penetrates the current collector and the first active material layer.

17. The electrode plate assembly according to claim 15, wherein, the main body comprises a second through-hole, and the second through-hole penetrates the riveting portion along the thickness direction of the electrode plate.

18. The electrode plate assembly according to claim 17, wherein, a number of the riveting portions is plural, a number of the first through-holes is plural, and the plurality of the riveting portions correspond to the plurality of the first through-holes one to one.

19. A battery cell, comprising a shell and the electrode plate assembly according to claim 1, and the electrode plate assembly is accommodated in the shell.

20. An electrical device, comprising the battery cell according to claim 19.
